(19) United States
(12) Patent Application Publication
(10) Pub. No.: US 2021/0110471 A1
(43) Pub. Date: Apr. 15, 2021

(54) METHOD, DEVICE, AND SYSTEM FOR DETERMINING FINANCIAL PROFILE BASED ON AGGREGATED ELECTRONIC MEASSAGES

(71) Applicant: Capital One Services, LLC, McLean, VA (US)

(72) Inventors: Kunal SHAH, McKinney, TX (US); Ponnazhakan SUBRAMANIAN, McKinney, TX (US); Sasi Kumar UNNIKRISHNAN, Plano, TX (US); Venkata Satya PARCHA, McKinney, TX (US); Satish CHIKKAVEERAPPA, McKinney, TX (US)

(73) Assignee: Capital One Services, LLC, McLean, VA (US)

(21) Appl. No.: 16/598,782

(22) Filed: Oct. 10, 2019

(51) Int. Cl. G06Q 40/02; G06Q 10/02; H04L 12/58

(52) U.S. Cl. CPC G06Q 40/025; H04L 51/046; G06Q 10/02

(57) ABSTRACT

The present disclosure provides methods and systems for collecting and processing user transaction information for determining a financial profile associated with an income generating activity of a user. One exemplary method comprises: accessing email data associated with a user of an account associated with a financial service; monitoring a user financial profile by scanning the email data associated with the user and identifying email messages including transaction information associated with an income generating activity; extracting income information by determining an amount of payment to the user from the identified email messages; determining user income associated with the income generating activity within a previous period based on the extracted income information; and generating, based on the user income within the previous period, an output indicating an adjustment of at least one service term of the account of the financial service.

### TECHNICAL FIELD

The present disclosure generally relates to methods, devices, and systems for automatically collecting and processing user transaction information associated with a product or service, which is provided by a user as an income generating activity, for determining a financial profile of the user associated with the income generating activity.

### BACKGROUND

Financial institutions offer various financial services to different consumer groups. A loan is a common form of financial service. Availability of financial services and terms of the financial service may vary depending on factors such as business needs, consumer demand, consumer financial profile, and the market conditions. With respect to a particular customer, one factor for setting the terms of a financial service is the customer's financial profile.

However, some customers, such as certain startup or small business owners, independent contractors, or self-employed individuals, may not currently have a steady and regular stream of income, and their updated financial transaction information may not be transmitted to financial institutions for timely evaluation of their updated financial profile. Further, some users may be engaged in different income generating activities, and their income information may be reflected in various forms of communication. Financial institutions thus face challenges in tracking user income information and determining the current user financial profile. For example, the financial institutions may not have access to the some or all of the user's income information as the users receive new income/payment from one or more third parties. These and other drawbacks exist, which cause difficulty for financial institutions to properly determine the users' current financial status and manage financial services for these customers.

### SUMMARY

The disclosed embodiments include methods, devices, and systems for determining a financial profile of the user associated with an income generating activity. According to some embodiments, one exemplary system comprises one or more memory devices storing instructions; and one or more processors configured to execute the instructions to perform operations comprising: receiving user credentials for accessing email data associated with a user, the user being associated with a user account of a financial service; accessing the email data associated with the user using the user credentials; monitoring a user financial profile by scanning the email data associated with the user and identifying email messages including transaction information associated with an income generating activity, wherein the identifying email messages comprises at least one of performing contextual analysis, searching for one or more key words in a message content, searching for an identification of at least one third party, identifying a message sender, or searching for account information; extracting income information by determining an amount of payment to the user from the identified email messages; determining user income associated with the income generating activity within a previous period based on the extracted income information; generating, based on the user income within the previous period, an output indicating an adjustment of at least one service term of the account of the financial service; and transmitting, based on the generated output, a notification to a user device associated with the user, the notification indicating the adjustment of the at least one service term of the account of the financial service.

According to some embodiments, one exemplary method comprises: accessing email data associated with a user of an account associated with a financial service; monitoring a user financial profile by scanning the email data associated with the user and identifying email messages including transaction information associated with an income generating activity, wherein the identifying email messages comprises at least one of performing contextual analysis, searching for one or more key words in a message content, searching for an identification of at least one third party, identifying a message sender, or searching for account information; extracting income information by determining an amount of payment to the user from the identified email messages; determining user income associated with the income generating activity within a previous period based on the extracted income information; generating, based on the user income within the previous period, an output indicating an adjustment of at least one service term of the account of the financial service; and transmitting, based on the generated output, a notification to a user device associated with the user, the notification indicating the adjustment of the at least one service term of the account of the financial service.

According to some embodiments, an exemplary non-transitory storage medium stores instructions that, when executed by at least one processor, cause the at least one processor to perform operations comprising: accessing email data associated with a user of an account associated with a financial service; monitoring a user financial profile by scanning the email data associated with the user and identifying email messages including transaction information associated with an income generating activity, wherein the identifying email messages comprises at least one of performing contextual analysis, searching for one or more key words in a message content, searching for an identification of at least one third party, identifying a message sender, or searching for account information; extracting income information by determining an amount of payment to the user from the identified email messages; determining user income associated with the income generating activity within a previous period based on the extracted income information; generating, based on the user income within the previous period, an output indicating an adjustment of at least one service term of the account of the financial service; and transmitting, based on the generated output, a notification to a user device associated with the user, the notification indicating the adjustment of the at least one service term of the account of the financial service.

It is to be understood that both the foregoing general description and the following detailed description are exemplary and explanatory only and are not intended to limit the scope of the present disclosure.

### BRIEF DESCRIPTION OF THE DRAWINGS

The accompanying drawings, which are incorporated in and constitute a part of this specification, illustrate exemplary disclosed embodiments and, together with the description, serve to explain the disclosed embodiments. In the drawings:

FIG. 1 is a schematic diagram illustrating an exemplary financial service management system, consistent with the present disclosure.

FIG. 2 is a schematic diagram of an exemplary user device for use in connection with a financial service management system, consistent with the present disclosure.

FIG. 3 is a schematic diagram of an exemplary financial service management server, consistent with the present disclosure.

FIG. 4 a flow chart of an exemplary method utilizing collection and processing of user transaction information, consistent with the present disclosure.

FIG. 5 is a flow chart of another exemplary method utilizing collection and processing of user transaction information, consistent with the present disclosure.

FIG. 6 is a flow chart of an exemplary method of interest rate determination for a financial service, consistent with the present disclosure.

FIG. 7 is a flow chart of an exemplary method of interest rate adjustment for a financial service, consistent with the present disclosure.

FIG. 8 is a flow chart of another exemplary method of interest rate adjustment for a financial service, consistent with the present disclosure.

FIG. 9 is a flow chart of an exemplary method of incentive determination associated with a financial service, consistent with the present disclosure.

### DETAILED DESCRIPTION

The following description is intended to provide a thorough understanding of the embodiments of the present disclosure, with detailed description of exemplary systems and methods for collecting and processing user transaction information for financial service management. Financial institutions may provide financial services to various groups of users/customers, such as different types of loans, checking and savings accounts, and debit and credit cards. The financial profile of a user, which may be an entity, an individual, a household, etc., is one factor in setting the terms of the financial service. Financial profile, as used herein, refers to the financial status information of a user associated with income generating activities. In some embodiments, financial profile may refer to overall financial status of the user, which reflects various factors, such as the user's savings, income, debts, and expenses. A user's financial profile can change over time and be updated based on the user's recent income or other recent financial activities.

Terms of financial services, as used herein, refer to features of a financial service. For example, for a loan, the terms may include a lending amount, a length of the loan, a monthly minimum payment amount, and monthly or annual interest rate of the loan. As another example, for a credit card service, the terms may include a credit limit, an annual or monthly minimum payment, annual or monthly service fees, a billing cycle, an interest rate, and an expiration date. For a line of credit, the service terms may include an interest rate, monthly payments, and the credit limit. The service terms may further include a termination date of the financial service. It is appreciated that embodiments of the present disclosure may apply to other types of financial services, and other types of service terms, which are not limited to the embodiments described herein.

In some embodiments, financial services may be provided to users who do not currently have a regular, steady stream of income. In such situations, financial institutions providing the financial services may need to monitor the financial profile of the user before and after the user applies for and obtains the financial service. For example, such users may be startup/small business owners seeking to start or expand their business, independent contractors who provide services as non-employees, or a self-employed individual who earns income by contracting with one or more individuals or entities without a consistent salary or wage. These users may engage in and earn income by providing various types of services or products, which are not limited by the present disclosure. In examples described below, the user may be an individual who engages in or seeks to engage in ridesharing services as a ridesharing service driver.

After extending a financial service, such as a loan or a line of credit to a user who does not have a regular income stream, a financial institution may monitor the financial profile of the user and the user's associated business or income generating activities, so that the terms of the loan or line of credit may be adjusted based on a timely evaluation of the user's financial profile.

In an exemplary embodiment, a user who is an independent contractor or a self-employed individual may apply for a loan from a financial institution to assist in starting or developing a business. The user may not currently have a regular stream of income, and the financial institution may set initial terms for the financial service based on the user's current financial profile. Based on the user's financial profile subsequent to obtaining the financial service, the financial institution may adjust the service terms and may continue to adjust the service terms on a periodic basis (e.g. monthly, quarterly, etc.).

As an example, a user may be an independent contractor seeking to obtain a loan to launch a business. Given that the user may not currently have a high credit score or a steady stream of income, the financial institution may only be willing to extend the financial service (such as a loan) with a very high interest rate or high monthly payment that the user may not be able to afford. In an embodiment, a financial institution may offer an affordable initial interest rate or set an affordable initial monthly payment amount so that the user can obtain the loan. Then, the financial institution may subsequently monitor the financial profile of the user and reserve an option to adjust terms (such as the interest rate) of the loan based on the income generating activities/financial profile of the user. For example, the financial institution can dynamically change/adjust the interest rate or monthly payment amount (or other periodical payments) based on the user's income generating activities and/the user's updated financial profile. The adjusted terms can be applicable for a certain period such as a month, half a year, or another term. Further, the financial institution can configure automatic payments according to the adjusted terms, such that the required payments can be automatically deducted or transferred. In addition, the adjustment can be made on a periodic basis such as weekly or monthly, based on the user's income generating activities and the user's current financial profile.

In the following description, a user engaged in a ridesharing service is used as an exemplary income generating activity. It is appreciated that the embodiments of the present disclosure may also apply in various scenarios where the user provides a product or engages in another type of service as an income generating activity, which is not limited by the examples described herein.

In an embodiment, the user may work with one or more individuals or entities who, as customers, transfer payment to the user (directly or indirectly) based on a service or product the user provides. The customers may also provide payment through a third-party platform associated with the product or service (such as a product transaction platform or a ridesharing service platform), which directs the payment to the user. Further, the payment can be processed through a third-party transaction processing platform. For example, the customers may provide payment to an online transaction processing platform (such as Paypal®), which can transfer payment to the user providing the product or service. The third-party platform may also provide to the user a periodic payment statement reflecting the payment the user receives.

The payment may be made or reflected in the form of a paper document such as a check, an electronic document such as an e-check, an electronic credit or debit transaction, or an electronic funds transfer to the user's account. The customers or a third-party platform may provide an email or a message notification to the user regarding the payment, or attach the payment document as an email attachment. Such emails or messages may include details of the specific transaction(s), such as the service or product involved, a time of service or delivery, identification of the customer, the customer's bank account information or the user's bank account information, a payment amount, and a time of payment. In cases where the payment is made in the form of a funds transfer to the user's account, the user may modify the settings regarding their bank account so that the bank may send an email notification to the user once the funds are transferred or deposited.

In an embodiment, a financial institution may monitor the user's financial profile by scanning the user's email data and identifying messages that include financial transactions associated with one or more income generating activities, such as payment statements, electronic payment documents such as e-checks, bank deposits or funds transfer notifications, and receipts. In some embodiments, email data may be retrieved or accessed from an inbox or email account associated with a financial institution for the purpose of receiving financial transaction related messages, including purchase or payment receipts etc. In some embodiments, the email data may be obtained from a user's personal email account associated with an email provider not affiliated with the financial institution. The financial institution may obtain the user's credentials for logging into the user's email account(s) periodically, so that recent financial transaction information can be identified and processed in a timely manner. Scanning user email data and identifying financial transaction information may be performed using a third-party application programming interface (API) which allows the financial institution to log in and access the user's email data.

Alternatively or additionally, the financial institution may be able to access a platform account associated with the user via an API (such an account for a ridesharing service platform associated with the user), which allows the financial institution to obtain user financial transaction information directly from the platform. For example, if the user is engaged in providing ridesharing services through a ridesharing service platform, the financial institution may access a ridesharing service platform account associated with the user. That way, the financial institution can identify and obtain user income information from the platform account, and monitor the user's service transaction record. Further, the financial institution may identify and extract user transaction information for further processing and analysis, and may also store the identified transaction information in association with the user's financial service account.

In an embodiment, scanning the user email data and identifying email messages including financial transaction information can be performed by contextual analysis or searching for relevant information associated with a financial transaction or income generating activity, such as key words identifying a financial transaction, or messages sent from a certain individual or entity, such as a customer for whom the user is providing a product or service. Alternatively, the user may send financial transaction documents or emails to a platform or database associated with the financial institution. For example, after receiving a payment document or message from a third party or a bank, the user may forward/upload the document or message to a designated database associated with the financial institution, so the financial institution can access and process such data to extract financial transaction information.

In an embodiment, based on the email data associated with the user, the financial institution may extract the financial transaction information associated with the user. For example, after email messages including financial transaction information are identified, the user's income or earnings can be determined by aggregating the payments reflected in the extracted financial transaction information. In some embodiments, the user's expenses or bills can also be extracted. That way, based on the user's earnings and expenses, the financial institution can evaluate the financial profile of the user by determining a net income associated with the user's income generating activities.

Based on the user's income or the user's financial profile, the financial institution may adjust the service terms of the financial service provided to the user. For example, the user may obtain a loan with an initially set interest rate. If the financial institution determines that the user is not maintaining an acceptable financial profile, such as not receiving an expected stream of income, the financial institution may adjust the interest rate, and may further adjust the amount of minimum monthly payment. Alternatively, if the user's financial profile is improving and the user's income is increasing over time or becoming steadier, the financial institution may reduce the loan interest rate or keep the interest at a lower level or adjust the minimum monthly payment to help the user pay down a financed amount faster. Likewise, service terms of other types of financial services can similarly be adjusted, such as lowering or increasing a credit limit, lowering or increasing monthly minimum payments (or recommended payments) for a credit card, extending the duration of the financial service, or making other financial services available.

Furthermore, based on the user's financial profile, the financial institution may further offer incentives to the user, such as offering coupons for certain products or services. In addition, based on the user's financial profile, the financial institution may configure or trigger automatic payments for the financial service, for example, to set a more affordable monthly payment amount, or to help the user pay down a financed amount faster. For example, the financial institution may configure an automatic payment plan based on the user's updated financial profile, which can indicate a recommended automatic monthly payment and the period required to pay down the entirety of the financed amount.

To further illustrate application of the technical solutions of the present disclosure, an exemplary application scenario is further described below in which the user is seeking to obtain a loan to finance a vehicle so that the user can engage in ridesharing services. With the development of the ridesharing service industry, many people are seeking employment or additional income through ridesharing service platforms such as Uber™, Lyft™, or Via. Some ridesharing service providers impose conditions on the vehicle to be used for ridesharing services. That is, when registering to become a ridesharing service driver, a user is required to have or obtain a vehicle in good conditions, for example, the vehicle model may not be older than a certain number of years. Some people do not have vehicles that meet the conditions and thus may not be able to be employed as a ridesharing driver unless they obtain another vehicle that satisfies the conditions. Some of them may therefore need to finance purchase of a new vehicle by obtaining loans. But some financial institutions do not offer loans for financing ridesharing vehicles due to various reasons, such as the rapid depreciation of the vehicle and associated risk of default. Some financial institutions may require a high interest rate for financing ridesharing vehicles. Consequently, some people may not be able to finance a new vehicle and engage in ridesharing services to obtain employment or additional income.

With the technical solutions provided herein, a financial institution may offer a loan to a user at a lower and affordable interest rate or dynamically adjustable monthly payment or interest rate, so that the user can obtain and afford the loan to finance a new vehicle. If the user is diligent, the user may be able to successfully generate income by working as a ridesharing service driver. The financial institution can reserve the option to adjust the interest rate or monthly payment (or other terms of the loan) based on the user's ridesharing service transaction information. When initially granting the loan, the financial institution may obtain the user's approval to allow the financial institution to access the user's email data, a related email system database, or a ridesharing service platform account associated with the user. This may be performed by the user providing credentials for logging in to their account(s), or change settings on their devices so that a third-party API can enable the financial institution or another entity to access such data.

When the user receives payment information from the ridesharing service platform, which can be in the form of an email notification including an e-check or with a payment statement attached. The financial institution may identify the emails received from the ridesharing service platform, extract the payment information, and determine the income of the user within a certain period. The user income can be used in determining adjustments of the terms of the loan. That is, the financial institution may monitor the income or financial profile of the user, and adjust the interest rate or weekly/monthly minimum payment amount associated with the loan. Further, based on the user's ridesharing service transaction information and income associated with the user's ridesharing services, the financial institution may offer incentive items to the user, such as coupons related to car service or accessories.

Reference will now be made to exemplary embodiments, examples of which are illustrated in the accompanying drawings and disclosed herein. The same reference numbers are used throughout the drawings to refer to the same or similar parts.

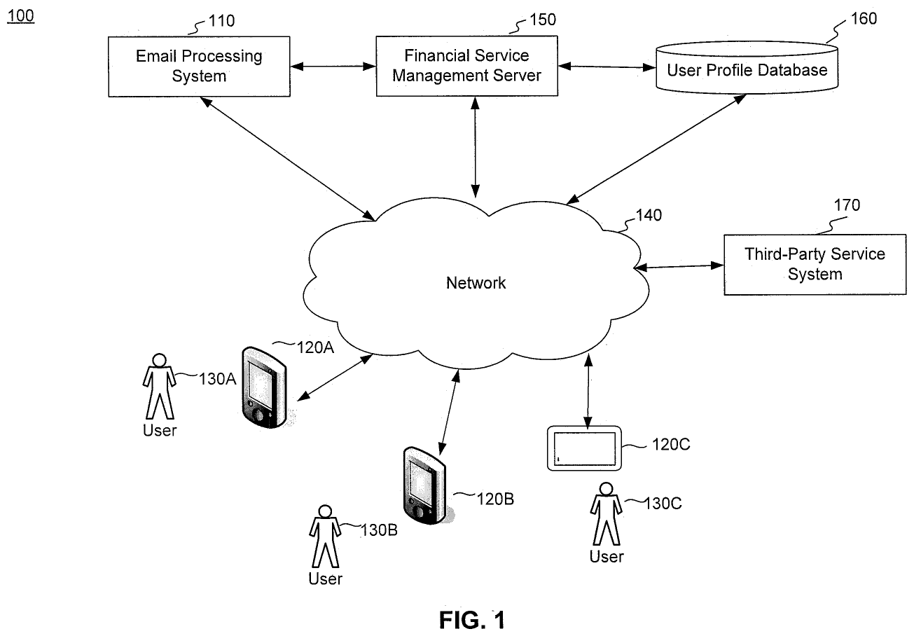

FIG. 1 is a schematic diagram illustrating an exemplary financial service management system 100, consistent with the present disclosure. For example, financial service management system 100 can serve as a platform for monitoring and managing financial services. Consistent with some embodiments of the present disclosure, financial service management system 100 can be used to manage financial services for users, including users without a regular stream of income, and adjust service terms of the financial services based on user income. User income, as used herein, may refer to the user's gross income or net income in cases where costs or user expenses are considered.

As shown in FIG. 1, financial service management system 100 includes an email processing system 110, one or more user devices 120A-120C (collectively referred to as user device(s) 120) respectively associated with users 130A-130C (collectively referred to as user(s) 130), a network 140, a financial service management server 150, a user profile database 160, and a third-party service system 170. The components and arrangements shown in FIG. 1 are only exemplary, as the system components used to implement the disclosed processes and features can vary.

Email processing system 110 may include hardware and/or software components that enable managing email accounts for a plurality of users. For example, email processing system 110 may include Internet Message Access Protocol (IMAP) servers and/or Message Application Programming Interface (MAPI) servers. A user can set up an account with log-in credentials for accessing email data. Email processing system 110 may receive, transmit, and store email messages and the attachments thereto, such as emails from another user or entity containing payment information. The user can log into their account and access the email data associated with the account. In some embodiments, email processing system 110 may be coupled with a server (such as financial management server 150) or a platform associated with a financial institution, so that the financial institution can access user email data.

Users 130 may access email data in email processing system 110, using their respective user devices 120, and can further communicate with financial service management server 150. As an example, user devices 120 may include a smart phone, a tablet, a computer monitor, an in-vehicle touch screen display device, and a laptop computer. User devices 120 may include video/audio input devices such as a video camera, a web camera, a microphone or the like. User devices 120 may also include one or more software applications that enable the user devices to engage in communications, such as IM, text messages, email, VoIP, and video conferences, with one another and/or with financial management server 150.

Network 140 facilitates communication and sharing of information between user devices 120, email processing system 110, and financial service management server 150. Network 140 may be any type of network that provides communications, exchanges information, and/or facilitates the exchange of information. For example, network 140 may be the Internet, a Local Area Network, a cellular network, a public switched telephone network (“PSTN”), or other suitable connection(s) that enables financial service management system 100 to send and receive information therebetween. Network 140 may support a variety of electronic messaging formats, and may further support a variety of services and applications for user devices 120.

Financial service management server 150 can be a computer-based system including computer system components, work stations, memory devices, and internal network(s) connecting these components. Financial service management server 150 may be configured to store and provide financial service related information, determine service terms associated with financial services, request and receive payments for financial services (such as from user devices 120), and communicate with third-party platforms (such as third-party service system 170) for incentive distribution associated with financial services via network 140.

For example, financial service management server 150 may be configured to access email processing system 110 and monitor user transaction information. Based on the user transaction information, financial service management server 150 can determine service terms or adjustments of service terms applicable for users 130 for a certain period such as the next month or the next year, and/or incentive compensation for users 130. Corresponding notifications can be sent to user devices 120 via network 140. The notifications may include information about the service terms, such as interest rate, and payment due dates. In some embodiments, the notifications may further include information indicating the factors leading to the service term determination or adjustment. As an example, the notification may indicate that the user's income in the last month is lower than a normal value or that the user's spending in the last month is higher than a normal value, and that these factors cause the interest rate to be higher or lower for the next month. The normal value can indicate a value set when the user applies for the financial service, or a value set arbitrarily by the financial institution providing the financial service. The notifications sent to user devices 120 may further include information about one or more incentive items for the user.

User profile database 160 includes one or more physical or virtual storages coupled with financial service management server 150. User profile database 160 can be configured to store user profile information of users 130. User profile information can include, for example, user account information (such as name, contact information, and images), financial profile of users 130, driving history information of users 130, associated user device information, financial service information and terms of financial services associated with users 130, data used to determine or adjust service terms, and incentive distribution information. User profile database 160 may further include information received from user devices 120, such as documents, texts, emails, images, audio signals, and video signals.

The data stored in user profile database 160 may be transmitted to financial service management server 150 for information analysis and notification generation. In some embodiments, user profile database 160 is stored in a cloud based server (not shown) that is accessible by financial service management server 150 and/or user devices 120 through network 140. While user profile database 160 is illustrated as an external device connected to financial service management server 150, user profile database 160 may also reside within financial service management server 150 as an internal component of financial service management server 150.

Third-party service system 170 can include third-party service platforms which can communicate with financial service management server 150. For example, third-party service system 170 may include service platforms for providing certain services or products that users 130 receive as incentives. For example, financial service management server 150 may communicate with third-party service system 170 to perform incentive compensation distribution for users 130. Financial service management server 150 may determine incentive items for users 130 such as free or discounted products or services, and coupons applicable to certain stores. Financial service management server 150 may provide the incentive related information to third-party service system 170, so the incentive items can be activated or redeemed.

As an example, financial service management server 150 may contract with third-party service system 170 for certain services or products, which users 130 receiving incentives can obtain for free or at discounted rates. Financial management server 150 can send a code or coupon to corresponding user devices 120. Users 130 can present the code or coupon to third-party service providers within third-party system 170, to receive the benefit.

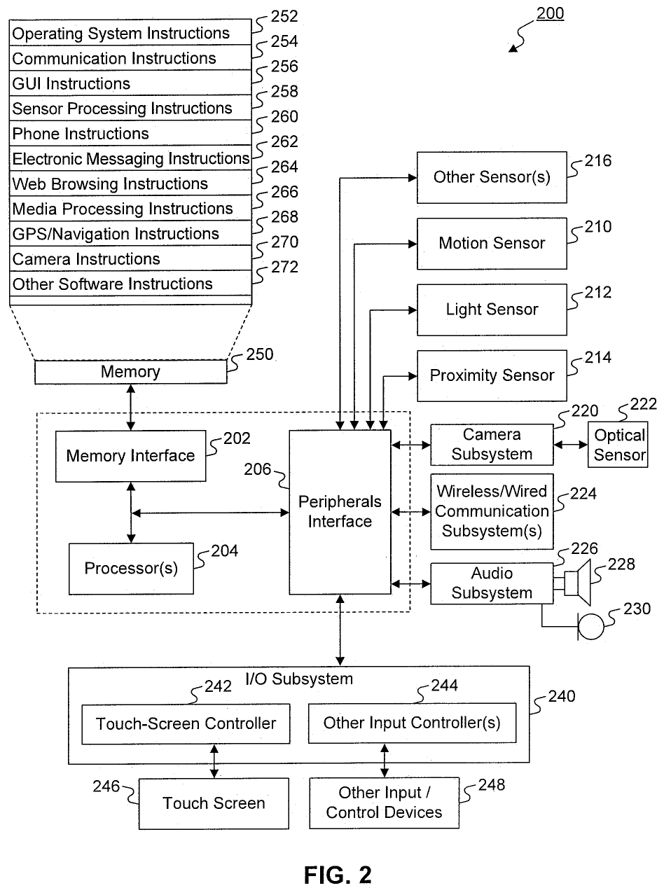

FIG. 2 is a schematic diagram of an exemplary user device 200 for implementing embodiments consistent with the present disclosure. User device 200 can be used to implement computer programs, applications, methods, processes, or other software to perform embodiments described in the present disclosure. User device 200 can serve as any of user devices 120 described above with reference to FIG. 1. As shown in FIG. 2, user device 200 includes a memory interface 202, one or more processors 204 such as data processors, image processors and/or central processing units, and a peripherals interfaces 206. Memory interface 202, one or more processor(s) 204, and/or peripherals interfaces 206 can be separate components or can be integrated in one or more integrated circuits. The various components in user device 200 can be coupled by one or more communication buses or signal lines.

Sensors, devices, and subsystems can be coupled to peripherals interfaces 206 to facilitate multiple operations. For example, a motion sensor 210, a light sensor 212, and a proximity sensor 214 can be coupled to peripherals interfaces 206 to facilitate orientation, lighting, and proximity functions. Other sensors 216 can also be connected to peripherals interfaces 206, such as a positioning system (e.g., GPS receiver), a temperature sensor, a biometric sensor, or other sensing device, to facilitate related functionalities. A GPS receiver can be integrated with, or connected to, user device 200. For example, a GPS receiver can be built into mobile telephones, such as smartphone devices. GPS software allows mobile telephones to use an internal or external GPS receiver (e.g., connecting via a serial port or Bluetooth). A camera subsystem 220 and an optical sensor 222, e.g., a charged coupled device (“CCD”) or a complementary metal-oxide semiconductor (“CMOS”) optical sensor, may be utilized to facilitate camera functions, such as recording photographs and video clips.

Communication functions may be facilitated through one or more wireless/wired communication subsystems 224, which includes an Ethernet port, radio frequency receivers and transmitters, and/or optical (e.g., infrared) receivers and transmitters. The specific design and implementation of wireless/wired communication subsystem 224 depends on the communication network(s) over which user device 200 is intended to operate. For example, in some embodiments, user device 200 includes wireless/wired communication subsystems 224 designed to operate over a GSM network, a GPRS network, an EDGE network, a Wi-Fi or WiMax network, and a Bluetooth® network.

An audio subsystem 226 may be coupled to a speaker 228 and a microphone 230 to facilitate voice-enabled functions, such as voice recognition, voice replication, digital recording, and telephony functions.

An I/O subsystem 240 includes a touch screen controller 242 and/or other input controller(s) 244. Touch screen controller 242 is coupled to a touch screen 246. Touch screen 246 and touch screen controller 242 can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with touch screen 246. While touch screen 246 is shown in FIG. 2, I/O subsystem 240 may include a display screen (e.g., CRT or LCD) in place of touch screen 246.

Other input controller(s) 244 are coupled to other input/control devices 248, such as one or more buttons, rocker switches, thumb-wheel, infrared port, USB port, and/or a pointer device such as a stylus. Touch screen 246 can, for example, also be used to implement virtual or soft buttons and/or a keyboard.

Memory interface 202 is coupled to a memory 250. Memory 250 includes high-speed random access memory and/or nonvolatile memory, such as one or more magnetic disk storage devices, one or more optical storage devices, and/or flash memory (e.g., NAND, NOR). Memory 250 stores an operating system 252, such as DARWIN, RTXC, LINUX, iOS, UNIX, OS X, WINDOWS, or an embedded operating system such as VXWorkS. Operating system 252 can include instructions for handling basic system services and for performing hardware dependent tasks. In some implementations, operating system 252 can be a kernel (e.g., a UNIX kernel).

Memory 250 may also store communication instructions 254 to facilitate communicating with one or more additional devices, one or more computers and/or one or more servers. Memory 250 can include graphical user interface (GUI) instructions 256 to facilitate graphic user interface processing; sensor processing instructions 258 to facilitate sensor-related processing and functions; phone instructions 260 to facilitate phone-related processes and functions; electronic messaging instructions 262 to facilitate electronic-messaging related processes and functions; web browsing instructions 264 to facilitate web browsing-related processes and functions; media processing instructions 266 to facilitate media processing-related processes and functions; GPS/navigation instructions 268 to facilitate GPS and navigation-related processes and instructions; camera instructions 270 to facilitate camera-related processes and functions; and/or other software instructions 272 to facilitate other processes and functions. For example, in the ridesharing service scenario described above, other software instructions 272 may include program instructions for functionalities related to a ridesharing service application, such as Uber™, Lyft™, or Via, where instructions regarding upcoming trips, routes, passenger information, navigation information, and ride fare information can be received and presented to the user.

In some embodiments, communication instructions 254 represent or include software applications to facilitate connection with financial service management server 150 to receive or transmit information regarding financial services. For example, electronic messaging instructions 262 may include a software program to generate a request for setting up a user account associated with a financial service. Further, electronic messaging instructions 262 may include software applications to receive service term determination and adjustment information and payment requests from financial service management server 150. Graphical user interface instructions 256 may include a software program that facilitates display of notifications to a user associated with the user device and facilitates user operations to provide user input, etc.

Each of the above identified instructions and software applications may correspond to a set of instructions for performing one or more functions described herein. These instructions may be implemented as separate software programs, procedures, or modules. Memory 250 may include additional instructions or fewer instructions. Furthermore, various functions of user device 200 may be implemented in hardware and/or in software, including in one or more signal processing and/or application specific integrated circuits.

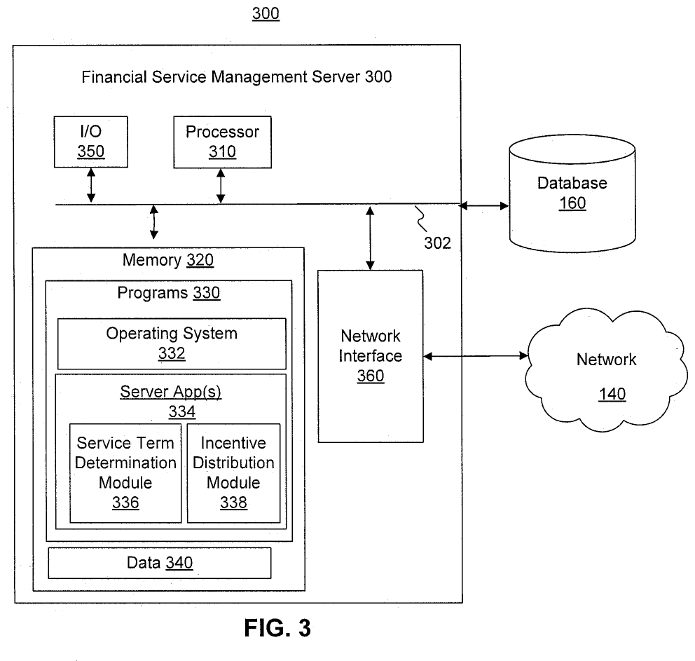

FIG. 3 is a schematic diagram of an exemplary financial service management server 300, in accordance with some embodiments of the present disclosure. Financial service management server 300 can serve as financial service management server 150 described above with reference to FIG. 1. Financial service management server 300 includes a bus 302 (or other communication mechanism) which interconnects subsystems or components for transferring information within financial service management server 300. Financial service management server 300 further includes one or more processors 310, input/output (“I/O”) devices 350, a network interface 360 (e.g., a modem, Ethernet card, or any other interface configured to exchange data with network 140), and one or more memories 320 storing programs 330 including, for example, an operating system 332, server app(s) 334, and data 340, and can communicate with an external user profile database 160 (which, for some embodiments, may be included within financial service management server 300). Server app(s) 334 can include a service term determination module 336 and an incentive distribution module 338. Financial service management server 300 may be a single server or may be configured as a distributed computer system including multiple servers, server farms, clouds, or computers that interoperate to perform one or more of the processes and functionalities associated with the disclosed embodiments.

Processor 310 may be one or more processing devices configured to perform methods and functionalities disclosed herein, such as a microprocessor manufactured by Intel™ or AMD™. Processor 310 may comprise a single core or multiple core processors executing parallel processes simultaneously. For example, processor 310 may be a single core processor configured with virtual processing technologies. In some embodiments, processor 310 may use logical processors to simultaneously execute and control multiple processes. Processor 310 may implement virtual machine technologies, or other technologies to provide the ability to execute, control, run, manipulate, store, etc., multiple software processes, applications, programs, etc. In some embodiments, processor 310 may include a multiple-core processor arrangement (e.g., dual core, quad core, etc.) configured to provide parallel processing functionalities to allow financial service management server 300 to execute multiple processes simultaneously. It is appreciated that other types of processor arrangements could be implemented that provide for the capabilities disclosed herein.

Memory 320 may be a volatile or nonvolatile, magnetic, semiconductor, tape, optical, removable, non-removable, or other type of storage device or tangible or non-transitory computer-readable medium that stores one or more program(s) 330 such as server apps 334 and operating system 332, and data 340. Common forms of non-transitory media include, for example, a flash drive, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM or any other flash memory, NVRAM, a cache, a register, any other memory chip or cartridge, and networked versions of the same.

Financial service management server 300 may include one or more storage devices configured to store information used by processor 310 (or other components) to perform certain functions related to the disclosed embodiments. For example, financial service management server 300 may include memory 320 that includes instructions to enable processor 310 to execute one or more applications, such as operating system 332, server apps 334, and any other type of application or software known to be available on computer systems. Alternatively or additionally, the instructions, application programs, etc., may be stored in external user profile database 160 (which can also be internal to financial service management server 300) or external storage communicatively coupled with financial service management server 300 (not shown), such as one or more databases or memories accessible over network 140.

User profile database 160 or other external storage accessible by financial service management server 300 may be a volatile or nonvolatile, magnetic, semiconductor, tape, optical, removable, non-removable, or other type of storage device or tangible or non-transitory computer-readable medium. Memory 320 and user profile database 160 may include one or more memory devices that store data and instructions used to perform one or more features of the disclosed embodiments. Memory 320 and user profile database 160 may also include any combination of one or more databases controlled by memory controller devices (e.g., server(s), etc.) or software, such as document management systems, Microsoft SQL databases, SharePoint databases, Oracle™ databases, Sybase™ databases, or other relational databases.

In some embodiments, financial service management server 300 may be communicatively coupled to one or more remote memory devices (e.g., remote databases (not shown)) through network 140 or a different network. The remote memory devices can be configured to store information that financial service management server 300 can access and/or manage. By way of example, the remote memory devices could be document management systems, Microsoft SQL database, SharePoint databases, Oracle™ databases, Sybase™ databases, or other relational databases. Systems and methods consistent with the disclosed embodiments, however, are not limited to separate databases or even to the use of a database.

Programs 330 include one or more software modules configured to cause processor 310 to perform one or more functions consistent with the disclosed embodiments. Moreover, processor 310 may execute one or more programs located remotely from one or more components of financial service management system 300. For example, financial service management server 300 may access one or more remote programs that, when executed, perform functions related to disclosed embodiments.

Programs 330 further include operating system 332 performing operating system functions when executed by one or more processors such as processor 310. By way of example, operating system 332 may include Microsoft Windows™, Unix™′ Linux™, Apple™ operating systems, Personal Digital Assistant (PDA) type operating systems, such as Apple iOS, Google Android, Blackberry OS, or other types of operating systems. Accordingly, disclosed embodiments may operate and function with computer systems running any type of operating system 332. Financial service management server 300 may also include software that, when executed by a processor, provides communications with network 140 through network interface 360 and/or a direct connection to one or more user devices 120.

In the presently described embodiment, server app(s) 334 cause processor 310 to perform one or more functions of methods consistent with embodiments of the present disclosure. As shown in FIG. 3, server apps 334 may include service term determination module 336 and incentive distribution module 338.

Service term determination module 336 causes processor 310 to determine a service term for a financial service. For example, service term determination module 336 may cause processor 310 to determine an interest rate for a financial service based on a user's financial profile, the user's credit score, a length of the financial service, a periodical payment amount, or a lending amount of the financial service. Service term determination module 336 may further cause processor 310 to determine an adjusted service term for user 130. For example, the financial service may be related to vehicle financing for providing ridesharing services. Based on the user's ridesharing service transaction information and ridesharing service income, service term determination module 336 may cause processor 310 to determine an adjusted interest rate for a current or future period, such as the current month, next month, or next year.

In some embodiments, service term determination module 336 may further include a machine learning module for determining service terms and service term adjustments using various machine learning algorithms, such as determining interest rates and interest rate adjustments, a periodical payment amount, or a credit limit. For example, a machine learning module can include a machine learning algorithm trained with a known set of training data, which include user's financial profile, information about financial services, and corresponding interest rates. The interest rates determined by the machine learning module can also be input as training data to adaptively improve the performance of the machine learning module. Similarly, the machine learning module can be trained and used for determining interest rate adjustment for a financial service based on a user's current financial profile or income. For example, in the case of user 130 being engaged in ridesharing services, based on factors such as the number of rides completed during a previous period (such as a month), the amount of service fee associated with rides completed during the previous period, and a payment history for the financial service, the machine learning module can be trained to calculate an adjusted interest rate for a current or future period. Various machine learning algorithms can be used, which are not limited in the present disclosure.

Incentive distribution module 338 can include program instructions for determining incentive compensation items for user 130. Such determination can be based on the user's current financial profile or income. For example, in the case of user 130 being engaged in ridesharing services, if within a given period such as one week, one month, or one year, user 130 completes a certain number of rides or the service fee amount associated with the rides exceeds a certain amount, user 130 can receive incentive items in the form of free or discounted vehicle service, coupons or discounts for vehicle accessories, or an interest rate reduction. Financial management server 300 can transmit the incentive compensation information to corresponding user devices 120 via network 140.

Data 340 may include user profile information such as their contact information, address, associated user device information, financial profile or income sources information, employment status, and so on. Data 340 may further include data used for determining service terms for a financial service for the users, such as the interest rates and any subsequent interest rate adjustments. Further, data 340 may include incentives that users 130 received, data used for determining incentives for users 130, and users' historical selection or preference regarding the incentive items. It is appreciated that data 340 may include information similarly stored in user profile database 160, and may share data with user profile database 160 or synchronize with data stored in user profile database 160.

Financial service management server 300 may also include one or more I/O devices 350 having one or more interfaces for receiving signals or input from devices and providing signals or output to one or more devices that allow data to be received and/or transmitted by financial service management server 300. For example, financial service management server 300 may include interface components for interfacing with one or more input devices, such as one or more keyboards, mouse devices, and the like, that enable financial service management server 300 to receive input from an operator or administrator (not shown).

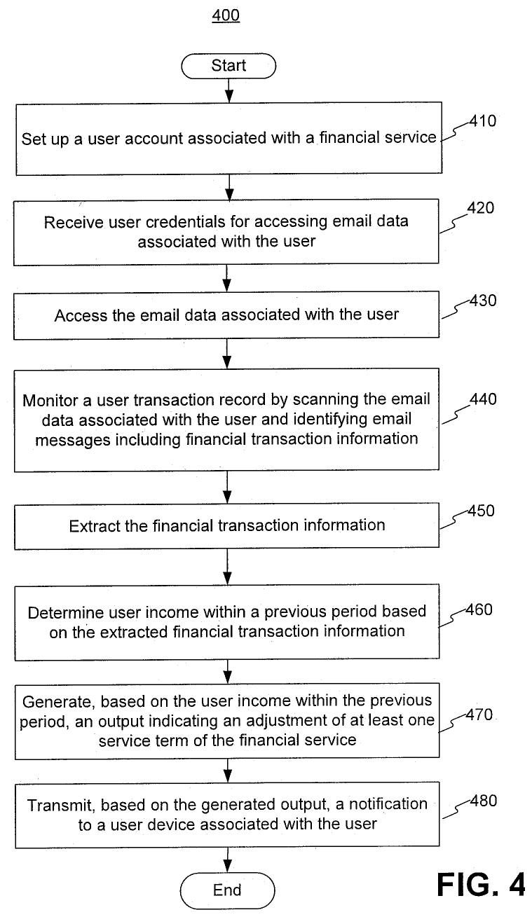

FIG. 4 is a flow chart of an exemplary method 400 utilizing collection and processing of user transaction information, according to some embodiments of the present disclosure. While method 400 is described herein as a sequence of steps, it is to be understood that the order of the steps may vary in other implementations. In particular, steps may be performed in a different order, or in parallel. It is to be understood that steps of method 400 may be performed by one or more processors, computers, servers, controllers or the like. In some embodiments, method 400 may be performed by a financial management server, such as financial service management server 150 (depicted in FIG. 1), or financial service management server 300 (depicted in FIG. 3). As shown in FIG. 4, method 400 includes steps 410-480.

In step 410, the financial service management server sets up a user account associated with a financial service. For example, a user may approach a financial institution and apply for a financial service, such as a loan. The financial service management server can set up a user account associated with the financial service and store user profile information. As explained above, user profile information can include, for example, a user name, an address, contact information, a photo, etc. The user profile information can also include user financial profile of the user, which can be provided by the user or gathered by the institution or a third-party agency. The financial institution can store the above information in association with the user account in a database within its service management platform.

In step 420, the financial service management server obtains user credentials, the user credentials being used for accessing email data associated with the user. In some embodiments, the user credentials may include log in information for logging into an email system to access email messages in the user's inbox. In some embodiments, the user credentials can also be log in information for a platform account associated with the user, such as an account registered with a transaction platform through which the user provides a product or service.

As an example, when the user applies for or obtains the financial service, the financial institution may request the user to grant access to the user's email data by providing their log in information. This can also be performed by a third-party API that allows the financial institution to access the email data. Further, the user may have more than one email accounts, and may provide the financial institution log-in credentials for some or all the email accounts which the user uses for receiving or transmitting financial transaction information. The user may further add more email accounts if new email accounts are created in which financial transaction information may be received.

In some embodiments, a user's email account can be created through a third party or an email system associated with/managed by the financial institution. The email account can be used for receiving/accessing financial transaction related messages. For example, this email account can be linked with the user's profile(s) associated with the user's income generating activities, such as the user's profile on a service platform (e.g., a ridesharing service platform) or product transaction platform (e.g., Etsy). That way, financial transaction emails/messages received by the user can be accessed by the financial institution through this email account, without the need of obtaining user credentials for the user's other email accounts. In step 430, using the user credentials, the financial service management server accesses email data associated with the user. The financial service management server may access the email data periodically such as on a daily, weekly, or monthly basis. As a result, any updated or recent financial transaction information of the user can be captured.

In step 440, the financial service management server monitors a user transaction record by scanning the email data associated with the user and identifying email messages including financial transaction information. For example, the user may enter into transactions with one or more third parties, for certain products or services. In the ridesharing service example mentioned above, the user may provide a ridesharing service to a rider through one or more ridesharing service platforms. After receiving the payment from the rider(s), the ridesharing service platforms may send a payment statement via email to the user for the trip(s) completed, including the amount of payment the user is receiving for completing the ride, and a description of the ride. The financial service management server may scan the user's email data and identify email messages including such payment statements from one or more ridesharing service platforms, and from other third parties with whom the user transacts. For example, in cases where the user provides ridesharing services through multiple ridesharing service platforms, the financial institution may aggregate the payments identified from the user's email data and determine a total income attributed to ridesharing services.

As another example, the user may provide products or services to a customer, who may send an email to the user once payment for such products or services is deposited in a designated account associated with the user, including the amount paid, the time of payment, account information, the products or services involved in the transaction, and identification information of one or both parties of the transaction.

Further, transaction related email messages may further include notifications from banks regarding deposits or withdrawals associated with the user's account(s). For example, the user may change settings of an application associated with a bank, which enables the user to receive notifications from the bank regarding deposits or withdrawals. The notifications may include details such as a time of the transaction, an amount deposited or withdrawn, a location of the transaction, an identity of the individual or entity involved in the transaction, and products or services involved in the transaction.

Identifying the email messages can be performed through keyword search, such as searching for keywords identifying a financial transaction such as “receipt,” “payment,” “transaction,” “statement,” “bank account,” “deposit,” “withdrawal,” or words identifying the third parties or the products or services involved. Further, the identification process can also be performed by searching for an email address, a logo, or other unique identifier(s) associated with third parties or banks accounts. Further, the identification process can be performed by contextual analysis based on the email content. Machine learning models can be trained to analyze the email content, and score the email based on the likelihood of the email including financial transaction data, which may help efficiently process a large amount of email data associated with various users.

In step 450, the financial service management server extracts financial transaction information from the identified email messages. For example, the payment amounts reflected in the identified emails can be extracted, and a total amount of payment the user received within a certain period can be determined. In some embodiments, the payment received by the user can further be categorized based on the third party from which the payment is received, or based on the product or service associated with the payment. For example, all payments received from one or more ridesharing service platforms based on the rides the user provided can be extracted, and a total amount of payment within a certain period can be determined. Further, the amount of user's expenses (payments made by the user to third parties), withdrawals, and purchases, can also be determined, which can also be categorized to provide a more comprehensive picture of the user's financial profile. For example, the purchases the users made at certain stores can be extracted based on the name of the store. Similarly, products or services purchased by the user can also be extracted, along with the items and the amounts involved in such purchases.

In step 460, the financial service management server determines user income within a previous period based on the extracted financial transaction information. In some embodiments, based on the identified transaction information, the financial institution may aggregate the amount of payment the user received from one or more third parties, or the amount of payment the user received for providing one or more goods or services, to determine a total income of the user within a previous period. The previous period can be of various lengths, for example, one week, one month, two months, or one year. For example, based on the extracted financial information, a total number of products or services the user sold can be determined, along with a total income associated with these products or services. As another example, if the user is engaged in ridesharing services, the payment received from each of the ridesharing platforms can be aggregated and the user's total income from ridesharing services can be determined.

In step 470, the financial service management server generates an output indicating an adjustment of at least one service term of the financial service, based on the user income within the previous period. By monitoring user transaction information as described above, the financial service management server can track the user's updated financial profile, and therefore adjust service terms of the financial service(s) accordingly. For example, if the user has maintained a steady stream of income within the previous month or previous year, the financial service management server may extend the expiration date of a line of credit the user is using, increase a credit limit, or lower an interest rate for a loan. Alternatively, if after obtaining the financial service, the user is not able to obtain or maintain an expected income, the financial service management server may reduce the risk of non-payment by terminating or adjusting the terms of the financial service. For example, the financial service management server can adjust the interest rate for the current or a future period, reduce or adjust the minimum monthly or annual payment, or reduce or adjust a service fee, etc. As explained above with reference to FIG. 1, various machine learning algorithms can be used in the determining the adjustment of the service terms.

In addition, the financial service management server can further configure automatic payment plans based on the user's updated financial profile. For example, based on the user's updated financial profile, the financial management server can configure an automatic payment plan for a loan the user obtained allowing the user pay down the loan in a shorter period of time. For example, based on the user's stream of income obtained through one or more income generating activities, the financial management server can configure an automatic payment plan providing one or more options indicating a monthly payment amount and a corresponding period over which the loan is to be paid off. The automatic payment plan can further be presented to the user and implemented upon receiving the user's approval. Further, the user selected/approved monthly payment can be automatically transferred and used to pay towards the loan.

In step 480, the financial service management server transmits a notification to a user device (such as a mobile phone) associated with the user, indicating the adjustment of the service term(s) and/or a required action from the user based on the service term adjustment. For example, if the service term adjustment involves an adjusted interest rate for this or next month, a notification can be transmitted to the user device indicating the adjusted interest rate, and required payment information for this or next month based on the adjusted interest rate. As another example, if the service term adjustment involves an adjusted minimum monthly payment, a notification can be transmitted to the user device indicating the adjustment in the minimum payment, the next payment due date, and the amount required for the next payment.

In some embodiments, based on the user income within the previous period, the financial institution may determine and provide certain incentive compensation for the user. For example, if the user's income is obtained through providing ridesharing services and the user maintains a steady stream of income, the financial institution may provide one or more incentives to the user such as free or discounted vehicle services or coupons for vehicle accessories or services.

With method 400, the financial service management server may collect and monitor a user's transaction record and the financial profile of the user, and accordingly adjust service terms of financial service(s) provided to the user. Method 400 can be applied to various users of financial services, including those who do not have a steady, consistent stream of income. To further illustrate the application and the advantages of the technical solutions provided herein, an exemplary application scenario in which the user engages in ridesharing services with a financed vehicle is described next.

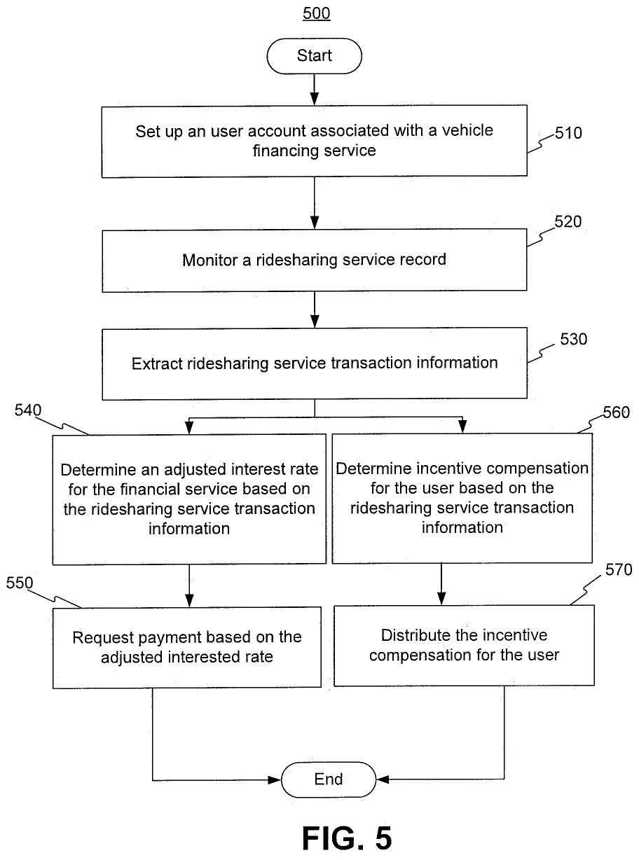

FIG. 5 is a flow chart of an exemplary method 500 for collection and processing of user transaction information, consistent with the present disclosure. Method 500 can be applied to managing an auto loan provided by a financial institution to a user who engages in ridesharing services with the financed vehicle. As shown in FIG. 5, method 500 includes steps 510-570. Method 500 can be performed by a financial service management server, such as financial service management server 150 described with reference to FIG. 1, or financial service management server 300 described with reference to FIG. 3. The financial service management server may be associated with the financial institution that provides the user with the auto loan.

In step 510, the financial service management server sets up a user account associated with a vehicle financing service. The user account may be set up based on a user request. The user may request an auto loan for a certain amount and a certain length. Based on the user's information and details of the auto loan, the user account can be set up to record and monitor activities associated with the auto loan.

The financial service management server may also acquire and store various types of user information in association with the user account. For example, when the user applies for the auto loan and before the loan is approved and issued, the financial service management server may acquire information about the user's financial profile, the user's credit score, previous loans and loan payment history, income sources; and the user's driving record and criminal record. After the auto loan is issued, the financial service management server may further store the user's ridesharing service transaction information in association with the user account.

The financial management server may determine an initial interest rate for the financial service. For example, the initial interest rate can be based on the acquired user information, such as the user's overall financial profile, credit score, and the user's driving history. The initial interest rate can be kept relatively low, so that the user can afford to obtain the loan to finance a vehicle in order to pursue employment or income through ridesharing services. Ridesharing service companies may require the vehicle to satisfy certain conditions to be used for providing ridesharing services. A user who does not have a vehicle that meets the conditions may not be able to finance a new vehicle if their credit score is low. Accordingly, a low initial interest rate may provide such users with an opportunity to finance a vehicle and engage in ridesharing services.

In step 520, the financial service management server monitors a ridesharing service record associated with the user, by scanning email data associated with the user and identifying email messages including ridesharing service transaction information. The financial service management server may access email data associated with the user using user-provided credentials. As described above with reference to FIG. 4, ridesharing service transaction information can be extracted based on the scanned email data and the identified email messages.

In some embodiments, the financial service management server may directly receive ridesharing service record associated with the user from a device associated with the user, such as from user device 120 depicted in FIG. 1. For example, an application can be installed on the user device, by which data associated with the user's ridesharing service can be transmitted to the financial service management server through the application in real time, periodically, or based on user operations. Alternatively, the application can be a feature of the ridesharing service application, wherein ridesharing service data can be shared with the financial service management server.

In step 530, the financial service management server extracts ridesharing service transaction information from the identified email messages. For example, the payment messages from the ridesharing service platform may include a number of rides completed, service time of the rides, other details associated with the rides, and payment the user receives for each ride. Such information can be extracted for further processing.

In step 540, the financial service management server determines an adjusted interest rate for the financial service based on the ridesharing service transaction information. As explained above, the interest rate for the financial service may be kept low so that users can afford to apply for and obtain the auto loan. However, the initial low interest rate may be kept low only for a limited amount of time, and may be subsequently adjusted based on the ridesharing service transaction information of the user. For example, based on the user's financial profile, the financial institution may subsequently adjust the interest rate to control or reduce risk of non-payment, or to ensure that the financed amount can be paid off or paid off over a shorter period of time. In some embodiments, if the user completes an acceptable number of rides or earns an acceptable amount of service income within a certain amount of time (for example, a month or a week), it indicates that the user is earning a stable income through the ridesharing service. For example, a service performance target can be set for a certain period, such as a target number of rides for the user, and/or a target amount of service fee for the user. The service fee amount may refer to the total fee collected from the riders, or the total service payment/income for the driver/user. The financial service management server may compare the number of rides the user completed with the target number of rides or compare the service fee amount with the target amount, to determine whether the user meets the service performance target. In some embodiments, the service performance target may be set by the user, the financial service management server, or the ridesharing service platform. For example, the service performance target may be set during the loan application process, based on the mutual agreement between the financial institution providing the loan and the user. Alternatively, the service performance target can also be set unilaterally by the financial institution when granting the loan.

The interest rate may be kept low if the user is maintaining or improving their financial profile. On the other hand, if after obtaining the loan, the user is not completing a sufficient number of rides or the service fee amount is low, the interest rate may be adjusted. The adjustment may be made periodically, such as on a monthly basis. That is, an adjustment can be made every month based on the user's ridesharing service performance in the previous month or the overall ridesharing service record. Alternatively, an adjustment can also be made more frequently or less frequently, which is not limited in the present disclosure. Further, the financial service management server may also determine not to adjust the interest rate for a current or a future period.

If in step 540, the financial service management server determines an adjusted interest rate, in step 550, the financial service management server requests payment based on the adjusted interest rate. Once the interest rate is adjusted based on the user's ridesharing service transaction information, the financial service management server may send a notification to the corresponding user device regarding the new rate, an effective date of the new rate, and an amount due for the next payment based on the new rate. The notification may further include information indicating factors affecting the adjustment, and dates for future adjustments. For example, the notification can be sent via email or text message to user device 120 depicted in FIG. 1, via network 140. The notification can also be sent to the user via a financial service application installed on user device 120.

In some embodiments, automatic payment can be made based on the adjusted interest rate, reducing the complexity of the payment management process. Based on the user's income identified from the ridesharing service transaction information, the interest rate (or the periodical payment) can be dynamically determined or adjusted periodically (such as on a bi-weekly or monthly basis). Automatic payment can be set up so that a corresponding payment amount for a current period can be automatically transferred to a loan/credit account associated with the financial service. The financial service management server may further send a notification to the user indicating the occurrence of the automatic payment. The notification may include details such as a time and amount of the payment made, and/or a future payment due date and amount.

In step 560, in financial service management server determines incentive compensation for the user based on the ridesharing service transaction information. Based on the user's ridesharing service transaction information, the financial service management server may provide the user with incentive items. It is appreciated that step 560 can be performed in parallel with step 540, and in some embodiments, step 560 is only performed when the user meets a service performance target, such as when the number of the rides the user completed with a previous period meets or exceeds the target number, or the service fee associated with the rides exceeds the target amount.

The incentive compensation can be in the form of free or discounted vehicle cleaning or maintenance services, gas services, and/or coupons for vehicle accessories or other products or services. The incentive compensation can be a benefit in various other forms, which is not limited in the present disclosure. For example, if the user completes a target number of rides or reaches a target number of service fee, the user may be eligible for incentive compensation. The incentive compensation may be evaluated periodically, such as on a weekly basis or a monthly basis. Alternatively, the incentive compensation may also be evaluated based on the overall ridesharing service record of the user, such as a total number of rides completed or a total amount of service fee collected.

In some embodiments, the incentive compensation may be in the form of a further reduction in the interest rate, which can be offered in addition to the adjusted interest rate in step 550. For example, if the user is able to meet the service performance target for an extended period of time (such as one year or a few months), the financial service management server may offer a further reduction in the already adjusted lower interest rate. It is appreciated that different forms of incentive compensation may be combined. Further, more than one form of incentive compensation may be presented to the user for the user's selection.

In step 570, the financial service management server distributes the incentive compensation to the user. The financial service management server may send information for redeeming the incentive compensation to the corresponding user device, such as a text message or an email, including a coupon or code. Further, as described above with reference to FIG. 1, the financial service management server may further send the incentive compensation information to third-party service system 170, so that a third-party service provider can provide corresponding service or products to the user.

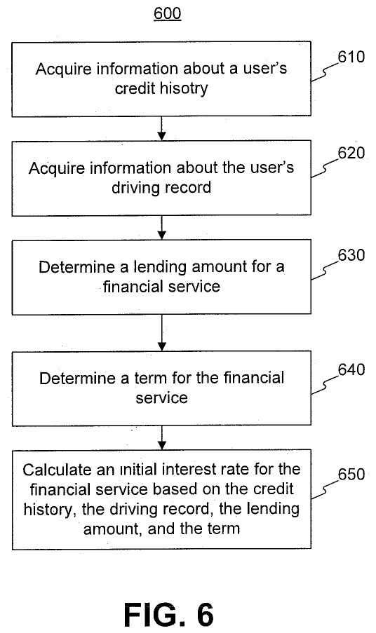

FIG. 6 is a flow chart of an exemplary method of interest rate determination for a financial service, consistent with the present disclosure. Method 600 can be performed by a financial service management server, such as financial service management server 150 depicted in FIG. 1 or financial service management server 300 depicted in FIG. 3. As shown in FIG. 6, method 600 includes steps 610-650.

In step 610, the financial service management server acquires information about a user's credit history. The user's credit history can include various information of the user, such as a credit score, financial service products the user has used, a payment history, timeliness of the payments, debts owed by the user, credit card information and payments, mortgages, student loans, and auto loans. For example, some of this information can be obtained from credit reporting agencies, financial institutions, or government agencies. Information about the user's credit history can be stored in association with the user's account, as part of the user's profile information.

In step 620, the financial service management server acquires information about the user's driving record. Such information may be submitted by the user. Alternatively, such information can be obtained from a motor vehicle management agency or insurance companies. Information about the user's driving record can be stored in association with the user's account, as part of the user's profile information.

In step 630, the financial service management server determines a lending amount for a financial service. For example, the financial service can be an auto loan for financing a vehicle to be used for providing ridesharing services. The lending amount can be the maximum lending amount the financial institution is providing for the user. The lending amount may be the same as or different from the amount requested by the user when applying for the financial service.

In step 640, the financial service management server determines a length/term for the financial service can be determined. The term for the financial service can be a preset period of time during which the loan is to be repaid. The term may vary depending on the type of the financial service or the user's financial profile. For example, the term for an auto loan may be 2 years, 3 years, 4 years, or a longer period. In some embodiments, the interest rate may be lower if the loan term is longer.

In step 650, the financial service management server determines an initial interest rate for the financial service based on the credit history, the driving record, the lending amount, and the term. In some embodiments, the initial interest rate may be determined based on one or more of the above factors, or further based on additional factors. For example, if the user has a low credit score, the interest rate may be set at a relatively higher rate than the rate for users with a higher credit score. As another example, the interest rate may be set higher for users with poor driving records. Further, as described above with reference to FIG. 1, machine learning algorithms may be used in the calculation of interest rates based on various factors.

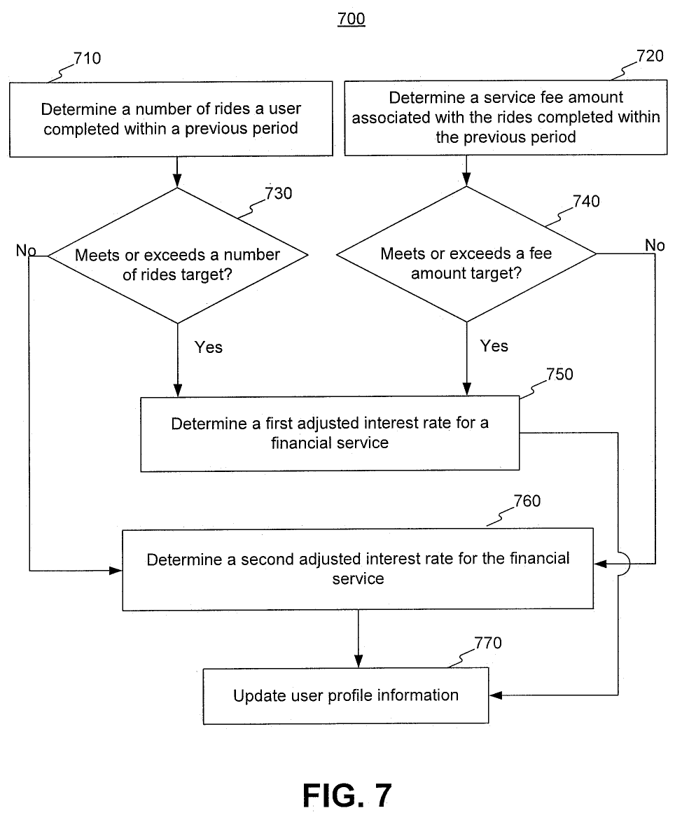

FIG. 7 is a flow chart of an exemplary method 700 of interest rate adjustment for a financial service, consistent with the present disclosure. According to some embodiments, the financial service may be an auto loan for financing a vehicle to be used for providing ridesharing services. Based on the user's ridesharing service record, the interest rate may be adjusted. Method 700 can be performed by financial service management server 150 depicted in FIG. 1, or financial service management server 300 depicted in FIG. 3. As shown in FIG. 7, method 700 includes steps 710-770.

In step 710, the financial service management server determines a number of rides a user completed within a previous period. The previous period may be one month, one week, or two months, the length of which is not limited herein. In some embodiments, the previous period may refer to the entire period since the user started providing ridesharing services with the financed vehicle.

In step 720, the financial service management server determines a service fee amount associated with the rides completed with the previous period. The determination can be made based on the financial transaction information extracted from user email data, as described above with reference to FIG. 4.

In step 730, the financial service management server determines whether the number of rides meets or exceeds a number of rides target. The number of rides target may be set by the user, the financial service management server 150, or the ridesharing service platform. Further, the number of rides target may refer to a target number for a set period of time, such as one month, one week, or two weeks, the length of which is not limited by the present disclosure.

In step 740, the financial service management server determines whether the service fee amount meets or exceeds a fee amount target. The fee amount target may be set by the user, the financial service management server 150, or the ridesharing service platform. Further, the fee amount target may refer to a target for a set period of time, such as one month, one week, or two weeks, the length of which is not limited by the present disclosure.

If the number of rides meets or exceeds the number of rides target in step 730, and the service fee amount meets or exceeds the fee amount target in step 740, then method 700 proceeds to step 750. In some embodiments, method 700 may determine interest rate adjustment based only on one of the number of rides target and the serve fee amount target. In those situations, if the number of rides meets or exceeds the number of rides target in step 730, or the service fee amount meets or exceeds the fee amount target in step 740, method 700 can proceed to step 750. In step 750, a first adjusted interest rate can be determined for a financial service. The first adjusted interest rate being equal to, lower than, or higher than a current interest rate. The current interest rate may be the same as or different from an initial interest rate set for the financial service. The first adjusted interest rate may apply to a current or future period of time, such as the current month, the next month, or the next week, which is not limited by the present disclosure. The first adjusted interest rate may also apply until it is further adjusted. For example, if the user taking the auto loan maintains a steady income by providing ridesharing services, for example, by meeting the number of rides target and the service fee amount target, a current low interest rate can be maintained, or the current interest rate can be reduced for an upcoming period.

If the number of rides does not meet or exceed the number of rides target in step 730, and the service fee amount does not meet or exceed the fee amount target in step 740, then method 700 proceeds to step 760. In some embodiments, method 700 may determine an interest rate adjustment based only on one of the number of rides target and the service fee amount target. In those situations, if the number of rides does not meet or exceed the number of rides target in step 730, or the service fee amount does not meet or exceed the fee amount target in step 740, method 700 can proceed to step 760. In step 760, a second adjusted interest rate for the financial service is determined. In some embodiments, the second adjusted interest rate can be equal to, or higher than the current interest rate.

Alternatively, the second adjusted interest rate may be set lower than the current interest rate in step 760, subject to future adjustments. For example, if the number of rides does not meet or exceed the number of rides target in step 730, and the service fee amount does not meet or exceed the fee amount target in step 740, it can indicate that the user is obtaining less income through the ridesharing services. In that case, the second interest rate (or the monthly payment) can be set lower for a certain period of time. That way, it can help the user manage the loan payments by reducing the amount of payment. When the user's financial situation changes, the second interest rate can then be adjusted accordingly. The second adjusted interest rate may apply to a current or future period of time, such as the current month, the next month, or the next week, which is not limited by the present disclosure. The second adjusted interest rate may also apply until it is further adjusted.

Further, as described above with reference to FIG. 1, machine learning algorithms may be used in the calculation of interest rates based on various factors. In steps 750 and 760, machine learning models can similarly be trained and used to determine interest rate adjustments based on the user's ridesharing service record. As a result, interest rates can be efficiently calculated for a large number of users.

In step 770, the financial service management server can update the user profile information. The number of rides the user completed within the previous period, the service fee amount associated with the rides completed, along with the adjusted interest rates, can be stored in association with the user account. Such information can be part of the user profile information and can be used in future interest rate adjustment determinations.

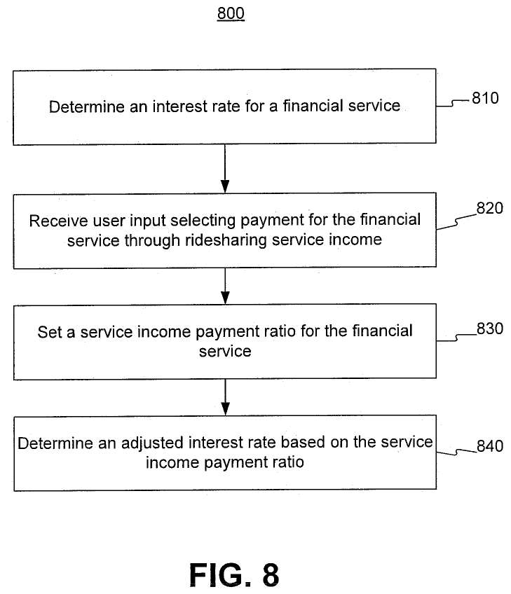

In some embodiments, as described below with reference to FIG. 8, the user may be allowed to repay a financial service with a portion of their future income, which, in the ridesharing service example above, is the user's future ridesharing service income. That is, payments from the user can include a payment based on a set interest rate, and a percentage of the user's expected income. For example, for a loan payment due next month, a financial service management server may allow the user to contribute a set percentage of the user's expected income next month towards the loan, in addition to a payment based on a set interest rate. Accordingly, the interest rate can be set lower, as additional payment will be made through the set percentage of the user's expected income. In some embodiments, the financial service management server may directly deduct the set percentage of income payment from the user's income.

FIG. 8 is a flow chart of another exemplary method 800 of interest rate adjustment for a financial service, consistent with the present disclosure. Method 800 can be performed by a financial service management server, such as financial service management server 150 depicted in FIG. 1 or financial service management server 300 depicted in FIG. 3. As shown in FIG. 8, method 800 includes steps 810-840. FIG. 8 is described using a scenario in which the user obtains a financial service and is engaged in ridesharing services. It is appreciated that the disclosed embodiments may also apply to scenarios in which the user provides a product or another type of service.

In step 810, the financial service management server determines an interest rate for a financial service (such as an auto loan). Determination of the interest rate may involve similar procedures described above with reference to FIG. 6 and FIG. 7. Reference can be made to the description provided above.

In step 820, the financial service management server receives user input selecting payment for the financial service through ridesharing service income. That is, the user selects to contribute a portion of their expected ridesharing service income towards payment for the financial service. In some embodiments, the payment through expected service income can be in addition to payment based on the set interest rate. For example, the user may desire to pay off a loan faster by contributing a portion of their expected income towards the loan.

User input can be received through an interface on a user device (such as user device 120 depicted in FIG. 1). For example, the interface can be an interface of a financial service application installed on the user device. The interface can present a list of payment options, allowing the user to select or input a desired ridesharing service income payment ratio. The desired ridesharing service income payment ratio may refer to a portion or a percentage of ridesharing service income the user desires to be paid towards the financial service. Alternatively, in some embodiments, the desired ridesharing service income payment ratio may indicate a fixed amount of funds taken out of the ridesharing service income by the financial service management server.

In some embodiments, the financial institution providing the financial service may set certain eligibility conditions for paying through ridesharing service income. For example, the option may only be available for users who have submitted timely payments for a certain period of time, or users who have maintained a steady ridesharing service income by consistently meeting the service performance targets such as monthly number of rides targets or service fee amount targets. Furthermore, in some embodiments, the user's eligibility for the option may further be evaluated periodically, such as every month, every few months, or every year. A user who is eligible to use the option may subsequently lose the eligibility if the user fails to pay for the financial service on time, or if the user fails to meet the service performance targets.

In step 830, the financial service management server sets a service income payment ratio for the financial service. The set service income payment ratio may be the same as or different from the desired ridesharing service income payment ratio selected or inputted by the user in step 820. For example, the financial service management server may impose limits on the payment ratio through ridesharing service income. The limits may also vary from user to user, or depend on the user's ridesharing service record. A user who maintains a steady stream of income through ridesharing services may be allowed to select a higher ratio of payment through ridesharing service income, while maintaining a low interest rate payment.

In step 840, the financial service management server determines an adjusted interest rate based on the service income payment ratio. In some embodiments, based on the service income payment ratio, interest rates may be further adjusted. For example, if the user selects to contribute a higher percentage of their ridesharing service income next month towards payment for the auto loan, the interest rate payment for next month may be adjusted to a lower rate. Arrangement can be made so that the set percentage of the user's ridesharing service income can be transferred to the financial institution.

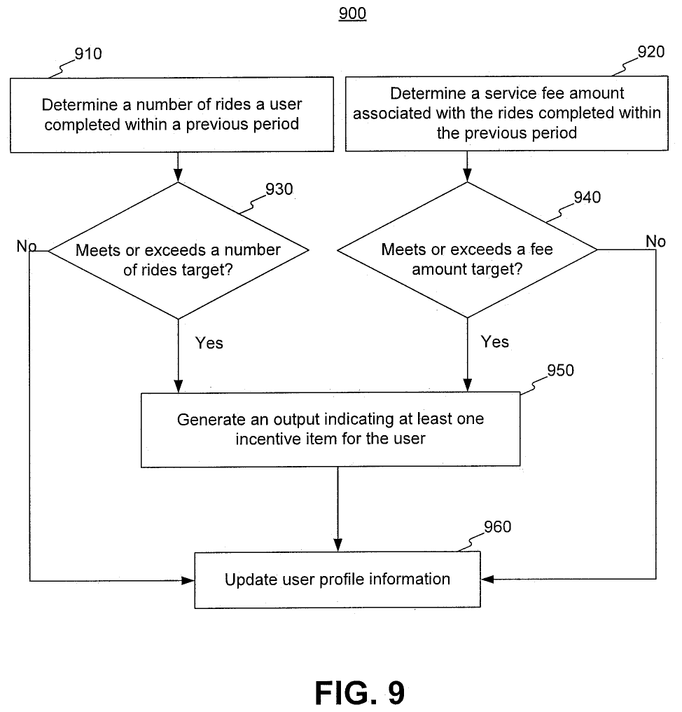

In some embodiments, users can be rewarded with incentive compensation. FIG. 9 is a flow chart of an exemplary method 900 of incentive determination associated with a financial service, consistent with the present disclosure. Method 900 can be performed by a financial service management server, such as financial service management server 150 depicted in FIG. 1 or financial service management server 300 depicted in FIG. 3. As shown in FIG. 9, method 900 includes steps 910-960.

In step 910, the financial service management server determines a number of rides a user completed within a previous period.

In step 920, the financial service management server determines a service fee amount associated with the rides completed with the previous period.

In step 930, the financial service management server whether the number of rides meets or exceeds a number of rides target.

In step 940, the financial service management server determines whether the service fee amount meets or exceeds a fee amount target.

Steps 910-940 may include similar procedures as described above with reference to steps 710-740. Reference can be made to the above description, which is not repeated herein.

If the number of rides meets or exceeds the number of rides target in step 930, and the service fee amount exceeds the fee amount target in step 940, the process proceeds to step 950. In some embodiments, method 700 may determine incentive compensation based only on one of the number of rides target and the serve fee amount target. In those situations, if the number of rides meets or exceeds the number of rides target in step 930, or the service fee amount meets or exceeds the fee amount target in step 940, method 900 can proceed to step 950. In step 950, at least one incentive item for the user can be determined. It is appreciated that the incentive compensation determination can also be made based on other factors, such as customer review and the user's payment history for the financial service.

As described above with reference to step 560 of FIG. 5, the incentive compensation can be in various forms. Examples of incentives include free or discounted vehicle cleaning services, gas services, coupons for vehicle accessories or other products, and interest rate reductions. In some embodiments, a list of incentive items may be presented to the user for the user's selection. The incentive compensation may be determined periodically, such as on a monthly or weekly basis. Alternatively or additionally, the incentive compensation may be determined and distributed when the user completes a certain number of rides or the service fee reaches a certain amount.

In step 960, the financial service management server updates user profile information. The determined number of rides, the service fee amount, and the incentive items the user received can be stored in association with the user account. Further, subsequent incentive items may be determined based on the user's preference, for example, the user's selection or redemption of the incentive items, or the user's historical purchases. If the user selected gas services in the past or has selected gas services for a number of times, subsequent incentive determination may take this into account and determine gas services as a preferred incentive item for the user.

In the description above with reference to FIGS. 4-9, the financial service management server is described as the entity performing the procedures and functionalities of the disclosed embodiments. In some embodiments, one or more functionalities of the financial service management server described in the present disclosure can be distributed among one or more of user devices such as user devices 120 depicted in FIG. 1. For example, one or more of user devices 120 may perform functions such as determining service term adjustments for financial services, or determining incentive compensation for users 130. The determination results can be provided to financial service management server 150 or user profile database 160 via network 140. In some embodiments, some or all of the logic for the above-described techniques may be implemented as a computer program or application or as a plug-in module or subcomponent of another application. The described techniques may be varied and are not limited to the examples or descriptions provided.

Moreover, while illustrative embodiments have been described herein, the scope thereof includes any and all embodiments having equivalent elements, modifications, omissions, combinations (e.g., of aspects across various embodiments), adaptations and/or alterations as would be appreciated by those in the art based on the present disclosure. For example, the number and orientation of components shown in the exemplary systems may be modified. Further, with respect to the exemplary methods illustrated in the attached drawings, the order and sequence of steps may be modified, and steps may be added or deleted.

Thus, the foregoing description has been presented for purposes of illustration only. It is not exhaustive and is not limiting to the precise forms or embodiments disclosed. Modifications and adaptations will be apparent to those skilled in the art from consideration of the specification and practice of the disclosed embodiments.

The claims are to be interpreted broadly based on the language employed in the claims and not limited to examples described in the present specification, which examples are to be construed as non-exclusive. Further, the steps of the disclosed methods may be modified in any manner, including by reordering steps and/or inserting or deleting steps.

Furthermore, although aspects of the disclosed embodiments are described as being associated with data stored in memory and other tangible computer-readable storage mediums, one skilled in the art will appreciate that these aspects may also be stored on and executed from many types of tangible computer-readable media, such as secondary storage devices, like hard disks, floppy disks, or CD-ROM, or other forms of RAM or ROM. Accordingly, the disclosed embodiments are not limited to the above described examples, but instead is defined by the appended claims in light of their full scope of equivalents.

1. A system, comprising:
an e-mail processing system configured to manage a plurality of e-mail accounts; and
a server configured to access the e-mail processing system, the server comprising:
a network interface configured to allow communication and sharing of information between the e-mail processing system and the server over a network;
one or more memory devices storing instructions; and
one or more processors configured to execute the instructions to perform operations comprising:
receiving user credentials for accessing email data associated with a user, the user being associated with a user account of a financial service;
accessing the email data associated with the user using the user credentials;
monitoring a user financial profile by:
scanning the email data associated with the user with an application programming interface; and
identifying email messages including ridesharing service transaction information received from at least one third party associated with a ridesharing service the user provides as part of an income-generating activity;
wherein the identifying email messages comprises at least one of performing contextual analysis, searching for one or more key words in a message content, searching for an identification of at least one third party, identifying a message sender, or searching for account information;
extracting income information by determining, from the identified email messages, an amount of payment to the user;
determining user income associated with the income generating activity within a previous period, based on the extracted income information;
determining, based on the ridesharing service transaction information, a number of rides the user completed within the previous period;
comparing the number of rides with a target number;
determining whether the number of rides meets or exceeds the target number;
generating, based on the user income within the previous period and the number of rides meeting or exceeding the target number, an output indicating an adjustment of at least one service term of the account of the financial service; and
transmitting, based on the generated output, a notification to a user device associated with the user, the notification indicating the adjustment of the at least one service term,
wherein the financial service is associated with vehicle financing for providing a ridesharing service, and
wherein, in response to the number of rides meeting or exceeding the target number, the output indicates an adjusted interest rate for the financial service, the adjusted interest rate being different than a current interest rate for the financial service.

2. The system according to claim 1, wherein the monitoring the user financial profile further comprises:
tracking a bank deposit and withdrawal history associated with the user.

3. (canceled)

4. The system according to claim 1, wherein the at least one service term of the account of the financial service includes at least one of a lending amount, an interest rate, a payment amount, or a credit limit.

5-7. (canceled)

8. The system according to claim 1, wherein the one or more processors are further configured to execute the instructions to perform:
determining, based on the ridesharing service transaction information, a service fee amount associated with rides the user completed within the previous period;
comparing the service fee amount with a target amount; and
in response to the service fee amount meeting or exceeding the target amount, generating an output indicating an adjusted interest rate for the financial service, the adjusted interest rate being the same as or different than a current interest rate for the financial service.

9. The system according to claim 8, wherein the one or more processors are further configured to execute the instructions to perform:
in response to the service fee amount not reaching the target amount, generating a second output indicating a second adjusted interest rate for the financial service, the second adjusted interest rate being the same as or different than the current interest rate for the financial service.

10. The system according to claim 1, wherein the one or more processors are further configured to execute the instructions to perform:
receiving user input selecting payment for the financial service through ridesharing service income;
determining a service income payment ratio for the financial service, the service income payment ratio being related to a portion of ridesharing service income contributing to payment for the financial service; and
generating an output indicating an adjusted interest rate of the financial service based on the service income payment ratio.

11. The system according to claim 10, wherein the service income payment ratio is determined based on at least one of:
user input indicating a service income payment ratio selection; or
the ridesharing service transaction information.

12. The system according to claim 1, wherein the one or more processors are further configured to execute the instructions to perform:
determining, based on the ridesharing service transaction information, a number of rides the user completed within the previous period;
comparing the number of rides with a target number; and
in response to the number of rides meeting or exceeding the target number, generating an output indicating at least one incentive item for the user account.

13. The system according to claim 12, wherein the at least one incentive comprises at least one of:
a reduction in a current interest rate for the financial service; or
a reward associated with vehicle-related services or products.

14. The system according to claim 1, wherein the one or more processors are further configured to execute the instructions to perform:
determining, based on the ridesharing service transaction information, a service fee amount associated with rides the user completed within a previous period;
comparing the service fee amount with a target amount; and
in response to the service fee amount meeting or exceeding the target amount, generating an output indicating at least one incentive item for the user account.

15. The system according to claim 14, wherein the at least one incentive comprises at least one of:
a reduction in a current interest rate for the financial service; or
a reward associated with vehicle-related services or products.

16. A method, comprising:
accessing, with a processor, email data associated with a user of an account associated with a financial service from an e-mail processing system over a network;
monitoring a user financial profile by scanning the email data associated with the user with an application programming interface and identifying email messages including ridesharing service transaction information received from at least one third party associated with a ridesharing service the user provides as part of an income-generating activity,
wherein the identifying email messages comprises at least one of performing contextual analysis, searching for one or more key words in a message content, searching for an identification of at least one third party, identifying a message sender, or searching for account information;
extracting income information by determining an amount of payment to the user from the identified email messages;
determining user income associated with the income generating activity within a previous period based on the extracted income information;
determining, based on the ridesharing service transaction information, a number of rides the user completed within the previous period;
comparing the number of rides with a target number;
determining whether the number of rides meets or exceeds the target number;
generating, based on the user income within the previous period and the number of rides meeting or exceeding the target number, an output indicating an adjustment of at least one service term of the account of the financial service; and
transmitting, based on the generated output, a notification to a user device associated with the user, the notification indicating the adjustment of the at least one service term of the account of the financial service,
wherein the financial service is associated with vehicle financing for providing the ridesharing service, and
wherein, in response to the number of rides meeting or exceeding the target number, the output indicates an adjusted interest rate for the financial service, the adjusted interest rate being different than a current interest rate for the financial service.

17. The method of claim 16, wherein the monitoring the user financial profile further comprises:
tracking a bank deposit and withdrawal history associated with the user.

18. (canceled)

19. The method of claim 16, wherein the at least one service term of the financial service includes at least one of a lending amount, an interest rate, a payment amount, or a credit limit.

20. A non-transitory storage medium storing instructions that, when executed by at least one processor, cause the at least one processor to perform operations comprising:
accessing, with the processor, email data associated with a user of an account associated with a financial service from an e-mail processing system over a network;
monitoring a user financial profile by scanning the email data associated with the user with an application programming interface and identifying email messages including ridesharing service transaction information received from at least one third party associated with a ridesharing service the user provides as part of an income-generating activity,
wherein the identifying email messages comprises at least one of performing contextual analysis, searching for one or more key words in a message content, searching for an identification of at least one third party, identifying a message sender, or searching for account information;
extracting income information by determining an amount of payment to the user from the identified email messages;
determining user income associated with the income generating activity within a previous period based on the extracted income information;
determining, based on the ridesharing service transaction information, a number of rides the user completed within the previous period;
comparing the number of rides with a target number;
determining whether the number of rides meets or exceeds the target number;
generating, based on the user income within the previous period and the number of rides meeting or exceeding the target number, an output indicating an adjustment of at least one service term of the account of the financial service; and
generating, based on the user income within the previous period, an output indicating an adjustment of at least one service term of the account of the financial service; and
transmitting, based on the generated output, a notification to a user device associated with the user, the notification indicating the adjustment of the at least one service term of the account of the financial service,
wherein the financial service is associated with vehicle financing for providing the ridesharing service, and
wherein, in response to the number of rides not reaching the target number, the output indicates a first adjusted interest rate for the financial service, the first adjusted interest rate being different than the current interest rate for the financial service.

21. The system according to claim 1, wherein, in response to the number of rides not reaching the target number generating a second output indicating a second adjusted interest rate for the financial service, the second adjusted interest rate being different than the current interest rate for the financial service.

22. The method of claim 16, wherein, in response to the number of rides not reaching the target number generating a second output indicating a second adjusted interest rate for the financial service, the second adjusted interest rate being different than the current interest rate for the financial service.

23. The non-transitory storage medium storing instructions of claim 20, wherein, in response to the number of rides meeting or exceeding the target number, generating a second output indicating a second adjusted interest rate for the financial service, the adjusted interest rate being different than a current interest rate for the financial service.
